(19) United States
(12) Patent Application Publication
(10) Pub. No.: US 2008/0082390 A1
(43) Pub. Date: Apr. 3, 2008

(54) Methods for Generating Auxiliary Data Operations for a Role Based Personalized Business User Workplace

(75) Inventors: Jennifer Hawkins, Toronto (CA); Ross McKegney, Toronto (CA); Tack Tong, Scarborough (CA); Qi Zhang, Ottawa (CA); Ying Zou, Kingston (CA)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/537,767

(22) Filed: Oct. 2, 2006

(51) Int. Cl. G06F 15/02

(52) U.S. Cl. 705/9

(57) ABSTRACT

Methods for generating auxiliary data operations for a role-based personalized business user workplace based on business processes includes analyzing a work-low of a business process to specify business items as an input or output of a task in the business process; identifying data operations for each one of the business items by examining associated attributes and usage of the business item; categorizing the data operations by associating common data operations to the business items, and attaching specific data operations based on the context of the workflow and use by particular business item instances of the business item; and assigning a user role for access to the business items.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present disclosure generally, relates to methods for generating auxiliary data operations for a role-based personalized business user workplace based on business processes.

2. Description of Background

A workflow enabling workplace defines information, services and applications to be integrated in a user's working environment and supports employees in performing business activities. Usually, business processes encapsulate knowledge of business roles, activities, resources, and the ways in which activities and resources are used by business roles. This knowledge can be used to generate role-based workflow enabling workplaces from business processes. The framework first extracts a role domain model from business processes. The role domain model summarizes tasks concerning role involvement in the business process. The framework then transforms it into a workplace model, which defines the content and layout information of the workplace. In the end, the framework generates workplace configuration files to automatically create the role-based workplaces. In this framework, tasks defined in workflows are interpreted as user interface components, such as task portlet, work items, and process progress status in a workplace. These user interface components provide functional steps that allow business users to perform their daily work in a workplace environment. In this context, a business process also contains data information that determines conditions to trigger a task and, result of the fulfillment of a task. However, the data information defined in business processes is not extracted into the role model.

To improve user experiences in a workplace, we need to provide more precise data information (i.e., input data or output data) about a task. In this way, a business user can understand the functionality of a task, verify the correctness of their operations once the task is carried out, and easily access auxiliary information for the fulfillment of a task. F,or example, a picture is a required input to a task—“add product attribute”, and a picture of a product may be added into a product catalog after performing this task. To assist a user to perform “add product attribute” task, it is useful to enable a user to preview a picture of the product before inserting it into a product catalog. It may be of importance that the user can verify the product description after the product description is created in a catalog. However, the data information is not well presented in currently available business process modeling specifications. Especially the possible operations on “picture” data and “catalog” data are not explicitly specified in the workflows. For the example of BPEL (Business Process Execution Language) specification, data information is described in terms of attributes in workflows. For instance, a “customer” data includes attributes, such as “Name”, and “Customer Number”.

The attributes define an abstraction for the data. For example, a customer record may include a lot more information. But from the perspective of the processes using the data only a subset of the attributes may be exposed, and may in fact be exposed in a simplified form. As an example, the business process data for customer may have a single ‘name’ attribute—that is physically stored as “firstname”, “middlename”, “lastname”, “title”, and “suffix”. The business process therefore views an abstraction of the real data. In addition, comment sections in workflows may contain descriptions for data usages. However the comments are expressed in a free form text. It is a challenging job to create a comment parser, in order to automatically derive operations on data. Moreover, the result of the parser is often ambiguous, and has low precisions towards the intended operations.

Another possible solution is to require business analysts to manually specify possible (operations on data when workflows are designed. Unfortunately, it may not be easy for a business analyst to envision the implementation of workflows in a workplace. Furthermore, data is subjected to constant changes in business processes. For example, coupon can be added to a business process during holiday season and removed after the season. It may be a tedious job to manually specify possible operations for short-lived business data, and manually update hard-coded data related user interface components in workplace applications.

To enrich the functionality of a workplace and enable it to be responsive to the underlying business processes, we provide an innovative technique that can automatically comprehend supporting data operations that can be directly or indirectly generated from business processes. Accordingly, there is a need for generating auxiliary data operations for a role-based personalized business user workplace based on business processes.

### SUMMARY OF THE INVENTION

The shortcomings of the prior art are overcome and additional advantages are provided through the provision of methods for generating auxiliary data operations for a role-based personalized business user workplace based on business processes. In one embodiment, the method comprises, in sequence, analyzing a workflow of a business process to specify business items as an input or output of a task in the business process; identifying data operations for each one of the business items by examining associated attributes and usage of the business item; categorizing the data operations by associating common data operations to the business items, and, attaching specific data operations based on the context of the workflow and used by particular business item instances of the business item; and assigning a user role for access to the business items.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have provided a technique to automatically identify data operations. Workflows are analyzed to extract data operations that manipulate data items specified in the workfows. The identified data operations can be used as suggestions for site developers to design user interfaces.

### BRIEF DESCRIPTION OF THE DRAWINGS

The subject matter, which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a user interface template generated from attributes of a business item.

FIG. 2 illustrates one example of data operations generated based on the usages in the workflow.

FIG. 3 illustrates one example of a hierarchal structure of data operations showing that an “OrderRequest” is an instance of “Order” business items.

The detailed description explains the preferred embodiments of the invention, together with advantages and features, by way of example with reference to the drawings.

### DETAILED DESCRIPTION OF THE INVENTION

In this invention, a technique is provided to automatically identify data operations that are requested by business processes. These data operations are not explicitly defined in business processes. From the perspective of workplace users, a set of possible data operations is identified on data objects and the users are supported to complete tasks defined in business processes. These data operations can be used as default data operations for the site developers who will provide the implementations of the identified data operations for workplace applications. More specifically, the identified data operations allow a user to access and manipulate the data required by a task enactment or generated from a task completion. In this approach, the knowledge embedded in the business process modeling domain is leveraged. Data operations related to business items (i.e., data) are inferred by analyzing implicit knowledge, for example, data attributes and data flow information, contained in an underlying workflow. Data types are then utilized as defined in workflows to extract common operations for the data of the same data type. Moreover, constraints on the usages of the identified data operation are defined so as to avoid data operations that divert the business activities from the intended workflow. Finally, the data description in workflows is enhanced by adding newly identified data operations as new attributes to the related data. As a result, data and the associated data operations are added to the role model of our proposed workplace generation framework. In this manner, user interface components can be automatically generated to represent and manipulate data in a role-based and personalized workplace.

The detailed methodology includes first analyzing the workflow to obtain business items. As used herein, business items are generally defined as business artifacts or business data used in business operations. Examples of business items are documents, invoices, or sales catalogs. A business item is modeled by attributes. Moreover, a business item can have business item instances that inherit attributes and default values of a business item. For example, an “Invoice” can be modeled as a business item. Individual invoices (such as Invoice #1) are business item instances. In this case, a business item instance can serve as an input to a task or can be generated by the completion of a task. The workflows can be analyzed to retrieve all business items. For the workflows modeled by Websphere Business Integration software 5.1 commercially available from IBM, business items and their attributes are well defined. Furthermore, business item instances and their usages in workflow can be obtained. The usages of a business item instance keep track of tasks that require the business item instance as inputs, tasks that emit the business item instance as outputs, and the roles that perform tasks. Based on this usage information, access controls to business data items and display data related user interface components in a workplace in an appropriate context can be defined. A parser to automatically carry out the analysis of workflows can be used.

Next, data operations for the business items are modeled once the business items are captured. A collection of data operations associated with each business item is first identified. Possible data operations for a business item are obtained by examining associated attributes of the particular business item, tasks, and implicit knowledge in the workflows. Moreover, the identified data operations are used as a supporting function. In this case, the data operations are intended to be independent from business activities defined in workflows.

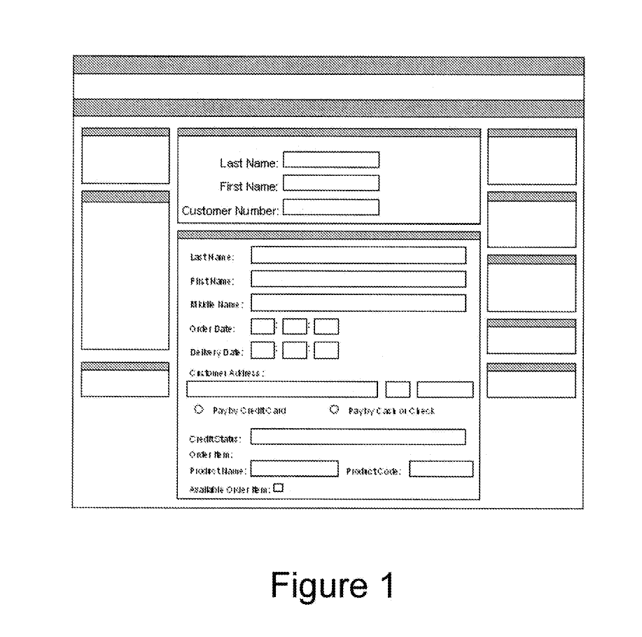

For attributes of a business item, the business item is automatically associated with setter and getter operations. From the perspective of user interface components, the setter operations of attributes can serve as templates for user interface components, and be represented as text fields that a user needs to fill in. FIG. 1 illustrates an example user interface template generated based on setter operations associated with Customer business item and Order business item. The getter operations can be rendered as buttons, triggered by users, and display the values of attributes in the user interface component. The use of setters or getters is determined by the rights (e.g., write or read-only) of the user, and context of the business item instance in a workflow. In the case of a user who is not a creator of a business item, the user can only view the data. However, if a user performs a task that creates a business item, the user is permitted to modify the values of attributes using a setter before the user completes the task.

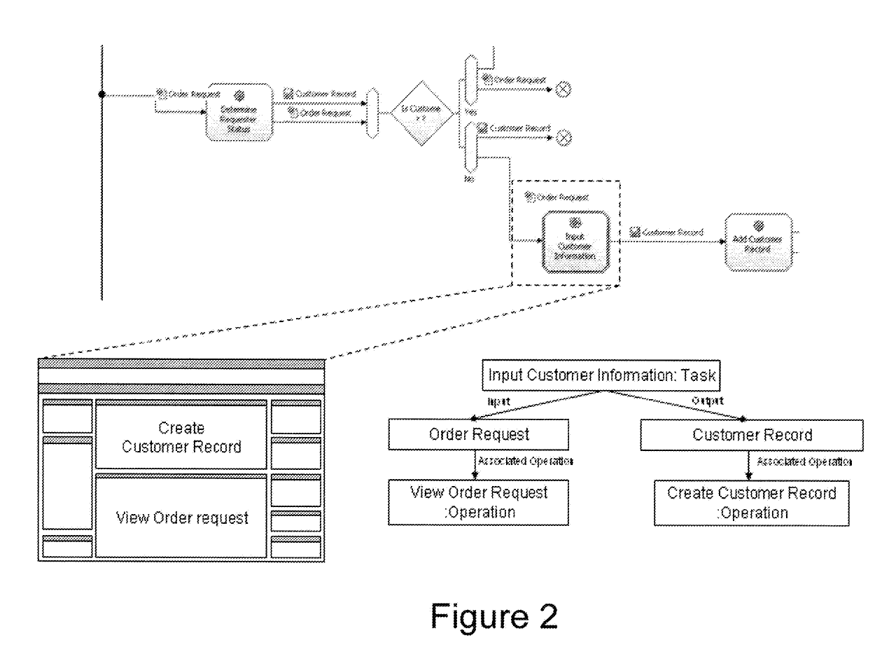

Business item instances can be either used as an input to a task or an output from a task. From the perspective of a role of a task the role is normally allowed to view the input information before he/she performs the task. When a business item instance appears as all output of a task, read, write and modify template operations can be associated for the business item instance. An example is illustrated in FIG. 2. The task “Input Customer Information” takes “Order Request” (an instance of “Order” business item) as input and emits “Customer Record” (an instance of “Customer” business item). User interface components are then generated corresponding to each business item instance. As such, the input “Order Request” is associated with the “View Order Request” operation and the output “Customer Record” is attached to “Create Customer Record” operation.

From this, commonly used tasks are extracted as data operations for business items. Tasks are considered as lowest level and inseparable activities that can be performed in a business process. Default data operations for the business item can be assigned when the same business item is frequently specified as an input or output of the same tasks. However to avoid data operations diverting the control flows from the designed control flow, only read-only tasks are considered when a business item instance is taken as an input.

These data operations are associated with contextual information, such as conditions, access control of roles, and invocation (sender and receiver) information. Moreover, based on the contextual information, some of these data operations are necessary to manipulate on all business item instances, but the others are optional.

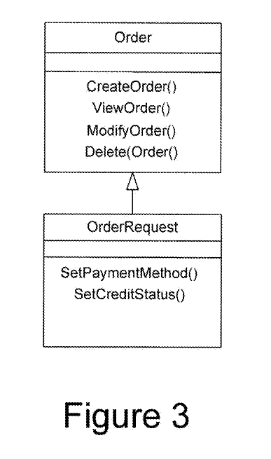

Once data operations are identified, data operations are then categorized to facilitate the invocation of data operations according to specific context or constraints. The identified data operations are divided into two categories, including common data operations (e.g., read-only template operations) and specific data operations (e.g., write-only template operations). Common data operations are associated to business items, and specific data operations that can be applied based on the context of workflow and used by particular business item instances are attached thereto. Business item instances can directly inherit operations defined in business items. In this sense, a hierarchical structure is created to classify operations for a business item and its instances. A business item is considered as a parent class, which contains the common data operations. In contrast, each instance of a business item is treated as its subclass, which includes specialized, contextual sensitive data operations. FIG. 3 illustrates that “OrderRequest” is an instance of the “Order” business item. It contains a set of setters in addition to the data operations specified in the “Order” business item.

In the context of workflows, a role is then assigned permissions to access certain data items. These permissions restrict the data operations allowed by the role to access data items. For example, if a data item can only be read by a role, then the data operations available to the role can be view/select. If a data item can be modified by a role, then the data operations available to the role can be view/change/select. Moreover, workflows contains constrains for the use of business items. Examples of constraints can be life cycles of data, dependencies, and conditions of data usage. Access permissions can then be inferred based on the workflow definition using the following criteria: a data item can be read by a role if it is the input of a task which the role can perform; a data item can be modified by a role if it is the output of a task which the role can perform; and constraints specified in workflows.

In summary, our invention provides an automatic technique to identify implicit data operations from business processes. These data operations are used to facilitate users to complete a task in a workflow enabled workplace. In addition, the present disclosure provides an automatic method to generate templates for data related user interface components; and supports automatic configuration of data and their related data operations based on the data constraints, and context specified in business processes. Therefore, a workplace user interface can be flexibly adapted to volatile business data, such as for a coupon in a promotion for example. Still further, the method maintains the interdependency between business modeling domain and business application development domain. Data operations and existing workflows can be enhanced by automatically adding newly identified data operations to the original data description without the interactions with business modeling analysts.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for generating auxiliary data operations for a role-based personalized business user workplace based on business processes, the method comprising, in sequence:
analyzing a workflow of a business process to specify business items as in input or output of a task in the business process;
identifying data operations for each one of the business items by examining associated attributes and usage of the business item;
categorizing the data operations by associating common data operations to the business items, and attaching specific data operations based on the context of the workflow and use by particular business item instances of the business item; and
assigning a user role for access to the business items.

2. The method of claim 1, wherein examining the associated attributes further comprises associating the attributes with setter and getter operations.

3. The method of claim 1, wherein the business item instances appear as an output of a task, wherein read, write and modify template operations are associated with the business item instances.

4. The method of claim 1, wherein the business items comprise business artifacts or data used in the business process.

5. The method of claim 1, wherein the business item attributes are assigned default values of the business item.

6. The method of claim 1, further comprising creating a hierarchal structure to classify data operations for the business items and corresponding business item instances.

7. The method of claim 1, wherein the user role is permitted access to view the input.

8. The method of claim 1, wherein the setter and getter operations of attributes provide a user interface template.

9. The method of claim 1, wherein analyzing the workflow comprises creating a parser to automatically carry out the analysis.

10. In a computer system having a graphical user interface including a display and a selection device, a method for generating auxiliary data operations for a role-based personalized business user workplace based on business processes comprises, in sequence:
analyzing a workflow of a business process to specify business items as an input or output of a task in the business process;
identifying data operations for each one of the business items by examining associated attributes and usage of the business item;
categorizing the data operations by associating common data operations to the business items, and attaching specific data operations based on the context of the workflow and use by particular business item instances of the business item; and
assigning a user role for access to the business items.

11. The method of claim 10, wherein the business item instances are a subtype of the business items.

12. The method of claim 10, wherein identified data operations are not explicitly identified in the business process.

13. The method of claim 10, wherein examining the associated attributes further comprises associating the attributes with setter and getter operations.

14. A computer-readable medium having computer executable instructions for performing a method comprises, in sequence:
analyzing a workflow of a business process to specify business items as an input or output of a task in the business process;
identifying data operations for each one of the business items by examining associated attributes and usage of the business item;
categorizing the data operations by associating common data operations to the business items, and attaching specific data operations based (m the context of the workflow and use by particular business item instances of the business item; and
assigning a user role for access to the business items.
